(19) United States
(12) Patent Application Publication
(10) Pub. No.: US 2007/0178316 A1
(43) Pub. Date: Aug. 2, 2007

(54) First surface mirror with sol-gel applied protective coating for use in solar collector or the like

(75) Inventor: Nathan P. Mellott, Northville, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 11/341,869

(22) Filed: Jan. 30, 2006

(51) Int. Cl. B05D 5/06; B32B 17/06

(52) U.S. Cl. 428/426; 427/162; 427/372.2; 428/432

(57) ABSTRACT

A first-surface mirror includes protective coating and is for use in a solar collector or the like. In certain example embodiments, a sol-gel coating is applied, in a wet form, over a reflective coating of a first surface mirror. The sol-gel coating is then heated following its application, to drive off liquid(s) of the sol-gel so that the coating densifies and forms a solid protective coating over the reflective coating. In certain example embodiments, the protective coating may be of or include silica or the like so as to protect the reflective coating and improve durability.

This application is related to a first-surface mirror including a sol-gel applied coating thereon for use in a solar collector or the like. In certain example embodiments of this invention, a sol-gel coating is applied, in a wet form, over a coating of a first surface mirror. The sol-gel coating is then heated to drive off certain liquid(s) of the sol-gel so that the coating densifies and forms a solid protective coating over the reflective coating. In certain example embodiments, the protective coating may be of or include silica or the like so as to protect the reflective coating and improve durability.

### BACKGROUND AND SUMMARY OF EXAMPLE EMBODIMENTS OF THE INVENTION

Solar collectors are known in the art. Example solar collectors are disclosed in U.S. Pat. Nos. 5,347,402, 4,056,313, 4,117,682, 4,608,964, 4,059,094, 4,161,942, 5,275,149, 5,195,503 and 4,237,864, the disclosures of which are hereby incorporated herein by reference. Solar collectors include at least one mirror (e.g., parabolic or other type of mirror) that reflects incident light (e.g., sunlight) to a focal location such as a focal point. In certain example instances, a solar collector includes one or more mirrors that reflect incident sunlight and focus the light at a common location. For instance, a liquid to be heated may be positioned at the focal point of the mirror(s) so that the reflected sunlight heats the liquid (e.g., water, oil, or any other suitable liquid) and energy can be collected from the heat or steam generated by the liquid.

FIG. 1 is a schematic diagram of a conventional solar collector, or a part thereof, where a parabolic mirror 1 reflects incident light from the sun 3 and focuses the reflected light on a black body 5 that absorbs the energy of the sun's rays and is adapted to transfer that energy to other apparatus (not shown). By way of example only, the black body 5 may be a conduit through which a liquid or air flows where the liquid or air absorbs the heat for transfer to another apparatus. As another example, the black body 5 may be liquid itself to be heated, or may include one or more solar cells in certain example instances.

FIG. 2 is a cross sectional view of a typical mirror used in conventional solar collector systems. The mirror of FIG. 2 includes a reflective coating 7 supported by a glass substrate 9, where the glass substrate 9 is on the light incident side of the reflective coating 7 (i.e., the incident light from the sun must pass through the glass before reaching the reflective coating). This type of mirror is a second or back surface mirror. Incoming light passes through the glass substrate 9 before being reflected by the coating 7; the glass substrate 9 is typically from about 4-5 mm thick. Thus, reflected light passes through the glass substrate twice in back surface mirrors; once before being reflected and again after being reflected on its way to a viewer. Second or back surface mirrors, as shown in FIG. 2, are used so that the glass 9 can protect the reflective coating 7 from the elements in the external or ambient atmosphere in which the mirror is located (e.g., from rain, scratching, acid rain, wind-blown particles, and so forth).

Unfortunately, the glass 9 in the second surface or back surface mirror of FIGS. 1-2 absorbs some of the energy of the sun's rays. For example, the glass 9 may absorb certain infrared, ultraviolet and/or visible light from the sun's rays, thereby preventing such absorbed light from reaching the black body to be heated in the solar collector. This is undesirable in that energy is being wasted due to the absorption of energy by the glass of the mirror.

Thus, it will be appreciated that there exists a need in the art for a more efficient mirror for use in solar collectors and the like. In particular, it would be desirable if less energy was wasted.

In certain example embodiments of this invention, a first (or front) surface mirror (FSM) is used in applications such as solar collectors. In a first or front surface mirror, the reflective coating is provided on the front surface of the glass substrate so that incoming light is reflected by the coating before it passes through the glass substrate. Since the light to be reflected does not have to pass through the glass substrate in first surface mirrors (in contrast to rear or second surface mirrors), first surface mirrors generally have higher reflectance than rear surface mirrors and less energy is absorbed by the glass. Thus, the first surface mirrors are more energy efficient than are rear or second surface mirrors. Certain example first surface mirror reflective coatings include a dielectric layer(s) provided on the glass substrate over a reflective layer (e.g., Al or Ag).

Unfortunately, when the overcoat dielectric layer becomes scratched or damaged in a front surface mirror, this affects reflectivity in an undesirable manner as light must pass through the scratched or damaged layer(s) twice before reaching the viewer (this is not the case in back/rear surface mirrors where the reflective layer is protected by the glass). Dielectric layers typically used in this regard are not very durable, and are easily scratched or otherwise damaged leading to reflectivity problems. Thus, it can be seen that front/first surface mirrors are very sensitive to scratching or other damage of the dielectric layer(s) which overlie the reflective layer.

It will be apparent from the above that there exists a need in the art for a first/front surface mirror for use in solar collectors and/or the like that is less susceptible to scratching or other damage of dielectric layer(s) overlying the reflective layer. It will also be apparent that there exists a need in the art for a protective coating that can be applied at reasonably low temperatures, and/or which does not introduce significant color to the mirror.

In certain example embodiments of this invention, a first-surface mirror (same as front surface mirror) is provided with a reflective coating and a protective coating provided over at least the reflective coating. The reflective coating may be formed in any suitable manner such as via sputtering or spraying. The protective coating protects the reflective coating of the mirror from elements in the external or ambient atmosphere in which the mirror is located (e.g., from rain, scratching, acid rain, wind-blown particles, and so forth). In certain example embodiments, the coating is applied over the reflective coating as a sol-gel so as to initially be applied in a wet form. The sol-gel coating is then heated to drive off certain liquid(s) of the sol-gel so that the coating densifies and forms a solid protective coating over the reflective coating. In certain example embodiments, the protective coating may be of or include silica or the like so as to protect the reflective coating and improve durability.

First-surface mirrors according to certain example embodiments of this invention may be used in applications such as one or more of: parabolic-trough power plants, compound parabolic concentrating collectors, solar dish-engine systems, solar thermal power plants, and/or solar collectors, which rely on mirror(s) to reflect and direct solar radiation from the sun. In certain example instances, the mirror(s) may be mounted on a steel or other metal based support system.

In certain example embodiments, the sol-gel coating (of one or more layers) is applied in wet form at a rather low temperature (e.g., room temperature) so that underlying reflective coating is not damaged during the application of the protective coating.

In certain example embodiments, the index of refraction (n) and/or thickness of the protective coating, following heating/curing thereof, is/are adjusted based upon indices of other layers of the mirror in order to achieve good reflective and/or optical properties of the mirror.

In certain example embodiments of this invention, there is provided a method of making a first surface mirror, the method comprising: forming a reflective coating on a glass substrate; forming a sol-gel on the glass substrate over the reflective coating, the sol-gel including a Si-inclusive precursor and one or more of water, alcohol, acid or base, and/or a hydroalcoholic mixture; heat treating the sol-gel at from about 200 to 1,000 degrees C for densifying and forming a glassy silica based protective coating over the reflective coating of the first surface mirror.

In other example embodiments of this invention, there is provided a first surface mirror, comprising: a reflective coating supported by a glass substrate; and a glassy silica based protective coating provided on the glass substrate over the reflective coating of the first surface mirror.

### BRIEF DESCRIPTION OF THE DRAWINGS

FIG. 1 is a schematic diagram of a conventional solar collector system.

FIG. 2 is a cross sectional view of the second surface mirror used in the conventional solar collector system of FIG. 1.

FIG. 3(a) is a plan view of a first surface mirror on a support according to an example embodiment of this invention.

FIG. 3(b) is a plan view of a first surface mirror on a support according to another example embodiment of this invention.

FIG. 4 is a cross sectional view of a first surface mirror that may be used in any of FIGS. 3(a) and/or 3(b), or any other type of applicable system, according to an example embodiment of this invention.

FIG. 5 is a cross sectional view of a first surface mirror that may be used in any of FIGS. 3(a) and/or 3(b), or any other type of applicable system, according to another example embodiment of this invention.

FIG. 6 is a cross sectional view of a first surface mirror that may be used in any of FIGS. 3(a) and/or 3(b), or any other type of applicable system, according to another example embodiment of this invention.

FIG. 7 is a cross sectional view of a first surface mirror that may be used in any of FIGS. 3(a) and/or 3(b), or any other type of applicable system, according to another example embodiment of this invention.

### DETAILED DESCRIPTION OF EXAMPLE EMBODIMENTS OF THE INVENTION

Referring now more particularly to the accompanying drawings in which like reference numerals indicate like parts throughout the several views.

Certain example embodiments of this invention relate to a first-surface mirror (FSM) that may be used in applications such as one or more of: parabolic-trough power plants, compound parabolic concentrating collectors, solar dish-engine systems, solar thermal power plants, and/or solar collectors, which rely on mirror(s) to reflect and direct solar radiation from the sun. In certain example instances, the mirror(s) may be mounted on a steel or other metal based support system. In certain example embodiments, the FSM mirror includes a reflective coating 15 of one or more layers that is supported by a glass substrate 9. The reflective coating 15 preferably includes at least one reflective layer (e.g., Al, Ag, Cr, and/or the like).

The reflective coating is covered by at least a protective coating 17. In certain example embodiments, the protective coating 17 is initially applied over the reflective coating in a sol-gel form so that it is wet when applied. The sol-gel may be of a type so that it can be applied using rather low temperatures of the substrate to which it is applied (e.g., temperatures lower than about 350 degrees C., more preferably lower than about 200 degrees C., and most preferably lower than about 100 degrees C., and preferably about room temperature) so that the underlying reflective coating is not significantly damaged during deposition of the protective coating. The sol-gel coating is then heated to drive off certain liquid(s) of the sol-gel so that the coating densifies and forms a solid protective coating 17 over the reflective coating 15. In certain example embodiments, the resulting protective coating 17 may be of or include silica (SiO₂) or the like so as to protect the reflective coating and improve durability of the mirror.

Generally speaking, a sol-gel procedure may be carried out as follows in certain example embodiments of this invention. A “sol” is prepared, which is a solution or suspension in water, alcohol and/or hydroalcoholic mixtures of precursor(s) of the element(s) whose oxide is to be prepared. For instance, precursors may be alkoxides, of formula M(OR)n, where M represents the element (e.g., Si) whose oxide is desired, the group —OR is the alkoxide moiety, and “n” represents the valence of M; soluble salt(s) of M such as chlorides, nitrates, and oxides may be used in place of alkoxides. During this phase, the precursor(s) may begin to hydrolyze (with or without an acid or base catalyst), e.g., alkoxide moieties or other anion bonded to the element M(s) may be replaced by —OH groups. Sol gelation may take from a few seconds to several days, depending on the chemical composition and temperature of the solution. During sol gelation, hydrolysis of the possibly remaining precursor(s) may be completed or substantially completed, and condensation may occur including reaction of —OH group(s) belonging to different molecules with formation of a free water molecule and an oxygen bridge between atoms M, M′ (alike or different). The product obtained in this sol gelation phase may be called alcogel, hydrogel, xerogel, or the like, or more generally “gel” as is widely used to cover all such instances. Gel drying then occurs; in this phase, the solvent is removed by evaporation or through transformation into gas (e.g., via heating in certain instances), and there is obtained a solid or dry body. Densification may be performed by heat treating, where a porous gel densifies thereby obtaining a glassy or ceramic compact oxide.

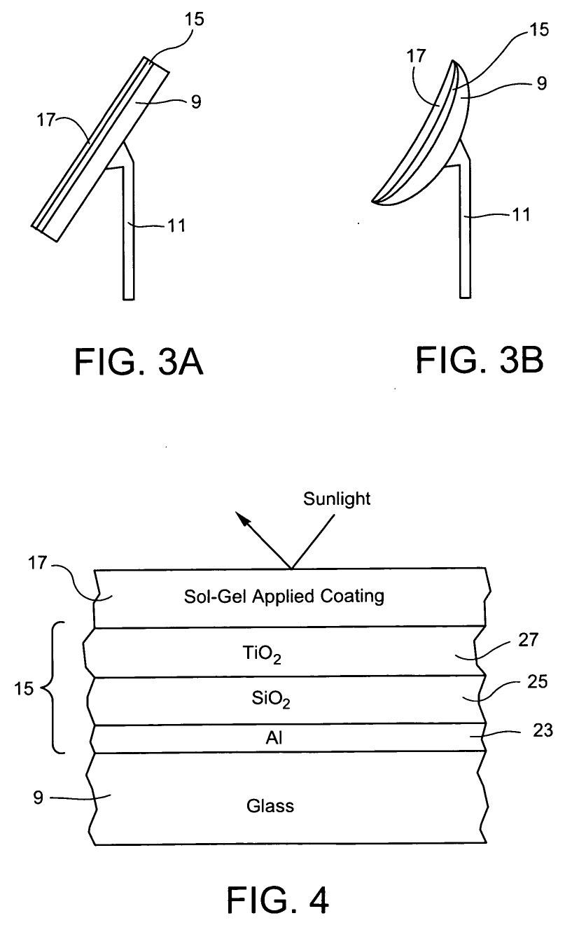

FIGS. 3(a) and 3(b) are side cross sectional views of first surface mirrors according to certain example embodiments of this invention. FIG. 3(a) illustrates that the FSM may be flat in certain example embodiments, while FIG. 3(b) illustrates that the FSM may be parabolic in shape as to its reflective surface in other example embodiments of this invention. The FSMs of FIGS. 3(a) and 3(b) each include a glass substrate 9 mounted on a support system 11 made of steel or the like. The support system 11 may be rigid or adjustable in different instances, but in any event supports at least the glass substrate 9 of the mirror. The glass substrate 9 is typically from about 3-10 mm thick, more preferably from about 3-6 mm thick, but may be other thickness in alternative example embodiments of this invention. The mirror includes the glass substrate 9 which supports each of a reflective coating 15 and a protective coating 17. As will be explained herein, the protective coating 17 is initially applied over the reflective coating 9 in a wet form (e.g., as a sol-gel), but is solid in the final product due to curing or the like. This mirror is referred to as a first-surface mirror or FSM because the reflective coating 15 is provided on the front surface of the glass substrate 9 so that incoming light from the sun or the like is reflected by the reflective coating 15 before it passes through the glass substrate 9. The reflective coating 15 includes one or more layers, at least one of which reflects incoming radiation from the sun or the like.

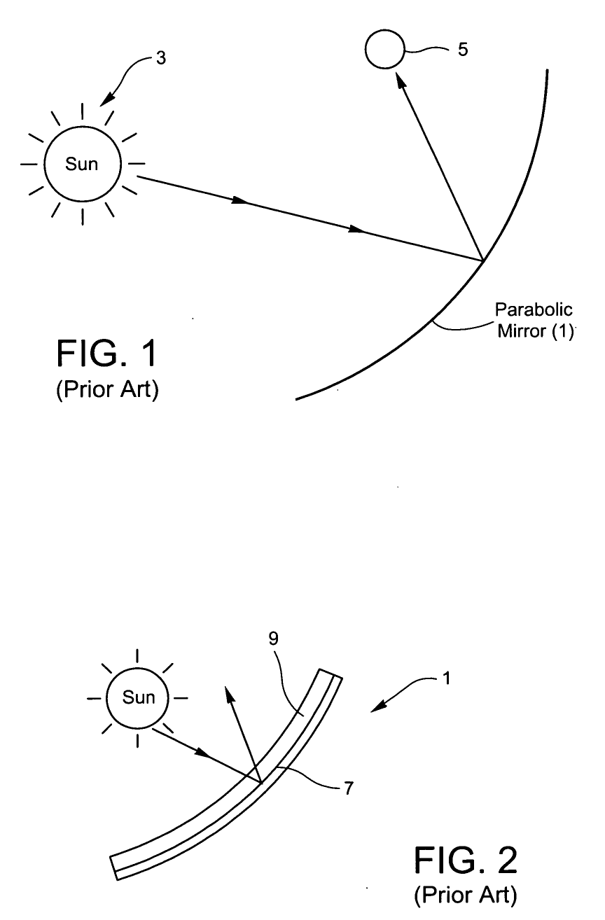

Different types of reflective coatings 15 may be used in the FSM in different example embodiments of this invention. For purposes of example only, FIGS. 4-7 illustrate different types of reflective coating 15 that may be used in a FSM according to example embodiments of this invention. The FSMs of FIGS. 4-7 may be used in the solar collector system of FIG. 1, and/or may be used in any of the FSM applications discussed herein or as shown in FIGS. 3(a)-3(b).

FIG. 4 is a cross sectional view of a first surface mirror (FSM) according to an example embodiment of this invention. The mirror of this example includes glass substrate 1 that supports a multi-layer reflective coating 15 including reflective layer 23, first dielectric layer 5 and second dielectric layer 27. Protective coating 17, of one or more layers, is provided on the substrate 9 over the reflective coating 15. Substrate 9 is preferably glass, but may be of plastic or even metal in certain instances. With respect to the reflective coating 15, the reflective layer 23 provides the main reflection, while dielectric layers 25, 27 work together to enhance the reflection and tune the spectral profile to the desired wavelength region. Example non-limiting materials for the dielectric layers 25, 27 are shown in FIG. 4. Optionally, another dielectric layer(s) (not shown) such as tin oxide and/or silicon oxide may be provided on the substrate under the reflective layer 23 so as to be located between substrate 9 and reflective layer 23 in order to promote adhesion of the reflective layer 23 to the substrate in certain alternative embodiments of this invention. According to other alternative embodiments, additional dielectric layer(s) (not shown) may be provided over the reflective layer 23 so as to be provided between layer 23 and dielectric layer 25. In other example embodiments, as part of coating 15 another silicon oxide layer (e.g., SiO₂) and another titanium oxide layer (e.g., TiO₂) may be stacked on top of layers 23-27 in this order so that four dielectric layers are provided instead of the two shown in FIG. 1 for reflective coating 15. In still further embodiments of this invention, layer 27 and/or layer 25 in the FIG. 1 embodiment may be eliminated.

Those skilled in the art will appreciate that the term “between” as used herein does not mean that a layer between two other layers has to contact the other two layers (i.e., layer A can be “between” layers B and C even if it does not contact layer(s) B and/or C, as other layer(s) can also be provided between layers B and C).

Glass substrate 9 may be from about 1-10 mm thick in different embodiments of this invention, and may be any suitable color (e.g., grey, clear, green, blue, etc.). In certain example instances, glass (e.g., soda lime silica type glass) substrate 9 is from about 3-10 mm thick, most preferably about 3-6 mm thick. When substrate 9 is glass, it has an index of refraction value “n” of from about 1.48 to 1.53 (most preferably about 1.51) (all indices “n” herein are at about 550 nm).

Reflective layer 23 of the reflective coating 15 may be of or include Al, Ag or any other suitable reflective material in certain embodiments of this invention. Reflective layer 23 reflects the majority of incoming light before it reaches glass substrate 9 and directs it toward a collection area away from the glass substrate, so that the mirror is referred to as a first surface mirror. In certain embodiments, reflective layer 23 has an index of refraction value “n” of from about 0.05 to 1.5, more preferably from about 0.05 to 1.0. When layer 23 is of Al, the index of refraction “n” of the layer 23 may be about 0.8, but it also may be as low as about 0.1 when the layer 23 is of or based on Ag. In certain example embodiments of this invention, a metallic layer 23 of Al may be sputtered onto the substrate 9 using a C-MAG rotatable cathode Al inclusive target (may or may not be doped) and/or a substantially pure Al target (>=99.5% Al) (e.g., using 2 C-MAG targets, Ar gas flow, 6 kW per C-MAG power, and pressure of 3 mTorr), although other methods of deposition for layer 23 may be used in different instances. In sputtering embodiments, the target(s) used for sputtering Al layer 23 may include other materials in certain instances (e.g., from 0-5% Si to help the Al bond to substrate 9 and/or layer 25). Reflective layer 23 in certain embodiments of this invention has a reflectance of at least 75% in the 500 nm region as measured on a Perkin Elmer Lambda 900 or equivalent spectrophotometer, more preferably at least 80%, and even more preferably at least 85%, and in some instances at least about 90% or even 95%. Moreover, in certain embodiments of this invention, reflective layer 23 is not completely opaque, as it may have a small transmission in the visible and/or IR wavelength region of from 0.1 to 5%, more preferably from about 0.5 to 1.5%. Reflective layer 23 maybe from about 20-150 nm thick in certain embodiments of this invention, more preferably from about 40-90 nm thick, even more preferably from about 50-80 nm thick, with an example thickness being about 65 nm when Al is used for layer 23.

Still referring to the FIG. 4 embodiment, first dielectric layer 25 may be of or include silicon oxide (e.g., approximately stoichiometric SiO₂ or any suitable non-stoichiometric oxide of silicon) in certain embodiments of this invention. Such silicon oxide may be sputtered onto the substrate 9 over layer 23 using Si targets (e.g., using 6 Si C-MAG targets, 3 mTorr pressure, power of 12 kW per C-MAG, and gas distribution of about 70% oxygen and 30% argon). In certain embodiments, first dielectric layer 25 has an index of refraction value “n” higher than that of layer 23, and preferably from 1.2 to 2.2, more preferably from 1.3 to 1.9, even more preferably from 1.4 to 1.75. For example, silicon oxide having an index of refraction of about 1.45 can be used for first dielectric layer 25 in certain example embodiments of this invention. First dielectric layer 25 may be from about 10-200 nm thick in certain embodiments of this invention, more preferably from about 50-150 nm thick, even more preferably from about 70-110 nm thick, with an example thickness being about 90 nm when the layer is of silicon oxide.

Second dielectric layer 27 in the FIG. 4 embodiment may be of or include titanium oxide (e.g., approximately stoichiometric TiO₂, or any suitable non-stoichiometric type of titanium oxide) in certain embodiments of this invention. Such titanium oxide may be sputter coated onto the substrate over layers 23 and 25 using Ti targets (e.g., 6 Ti C-MAG targets, pressure of 3.0 mTorr, power of 42 kW per C-MAG target, and a gas flow of about 60% oxygen and 40% argon). In certain embodiments, second dielectric layer 27 has an index of refraction “n” higher than that of layers 23 and/or 25, and preferably from 2.0 to 3.0, more preferably from 2.2 to 2.7, even more preferably from 2.3 to 2.5. For example, titanium oxide having an index of refraction value “n” of about 2.4 can be used for second dielectric layer 27 in certain example embodiments of this invention. Other suitable dielectrics may also be used in the aforesaid index of refraction range. Second dielectric layer 27 may be from about 10-150 nm thick in certain embodiments of this invention, more preferably from about 20-80 nm thick, even more preferably from about 20-60 nm thick, with an example thickness being about 40 nm when the layer is titanium oxide. As will be appreciated by those skilled in the art, layers 25 and 27 (and coating 17) are substantially transparent to visible light and much IR radiation so as to enable visible light and IR radiation to reach reflective layer 23 before being reflected thereby. In certain example embodiments, each of layers 23-27 may be sputter coated onto the substrate 9.

The protective coating 17 (which may be the outermost layer of mirror in certain example embodiments) is formed as follows in certain example embodiments of this invention. The protective coating is initially applied in a wet form over the reflective coating 15. For example, the protective coating may be initially applied as a sol-gel over the reflective coating 15 in certain instances. The sol-gel may include, for example, a wet/liquid mixture of: (a) silane precursor, (b) alcohol, (c) water, and (d) acid(s) or base(s). For purposes of example, the silane or silica precursor may be TEOS (Tetra-ethyl-ortho-silicate), TMOS (Tetra-methyl-ortho-silicate), glycidoxypropyl-tyimethoxysilane, or the like in certain example embodiments of this invention, and the alcohol may be ethanol and/or isopropanol in certain example embodiments, although other silanes and alcohols may instead be used. An example acid is nitric or hydrochloric acid, although other acid(s) may instead be used. This mixture of (a)-(d) may make up the sol-gel coating in certain example embodiments of this invention. The sol gel may be applied on the substrate 9 over the reflective coating 15 via curtain coating, spray coating, roll coating, or in any other suitable manner. As explained above, the sol-gel may be applied wet at room temperature in certain example embodiments of this invention to avoid any damage to the underlying coating 15.

In order to form the protective coating 17, the sol-gel is heat treated following its application on the substrate. The sol-gel coating is heated (e.g., from about 200 to 1,000 degrees C., more preferably from about 200-800 degrees C., even more preferably from about 300-600 degrees C.) to drive off certain liquid(s) of the sol-gel (e.g., the water and acid) so that the silica precursor (e.g., TEOS) turns into a solid silica based network whereby the coating densifies and forms a solid protective coating 17. In certain example embodiments, the resulting protective coating 17 may be of or include silica (SiO₂) or the like so as to protect the reflective coating 15 and improve durability of the mirror.

The resulting protective coating 17 is made up of at least about 75% SiO₂, more preferably at least about 80%, and most preferably at least about 85%, in certain example embodiments of this invention. Thus, a highly transmissive silica based protective coating 17 is provided. In certain example embodiments of this invention, the protective coating 17 may be from about ¼ to twenty μm thick, more preferably from about 1-10 μm thick. The relative small thickness of the coating 17 permits reflectance of the mirror to be high. In certain example embodiments of this invention, the protective coating 17 has an index of refraction value “n” of from about 1.4 to 1.7, more preferably from about 1.4 to 1.55, and most preferably from about 1.4 to 1.5 (e.g., about 1.45) in certain example embodiments of this invention.

While the silica based protective coating 17 is formed via a sol-gel technique in certain example embodiments as described above, it is also possible to form the coating 17 via CVD or sputtering in other example instances.

In applications where a focusing mirror is desired (e.g., see FIGS. 1 and 3(b)), the glass 9 may be bent as desired before or after application of the coating 15 and/or 17 in different embodiments of this invention.

The visible transmission and/or the Tₛₒₗₐᵣ transmission of the protective coating 17 is/are at least about 80%, more preferably at least about 85%, and most preferably at least about 90% or 95% in certain example embodiments of this invention. Thus, not much radiation is absorbed by the protective coating 17 thereby permitting more radiation to reach the item/body to be heated in solar collector applications for example.

By arranging the respective indices of refraction “n” of layers 23-27 and coating 17 as discussed above, it is possible to achieve both a scratch resistant and thus durable first surface mirror where it is difficult to scratch protective layer 9, and good anti-reflection properties to permit the mirror's optical performance to be satisfactory. The provision of protective coating 17 that is durable and scratch resistant, and highly transparent to visible and IR radiation, and has a good index of refraction, enables the combination of good durability and good optical performance to be achieved. The first surface mirror may have a Total Solar (Tₛₒₗₐᵣ) reflection and/or visible reflection of at least about 80%, more preferably of at least about 85%, and even at least about 90% or 95% in certain embodiments of this invention.

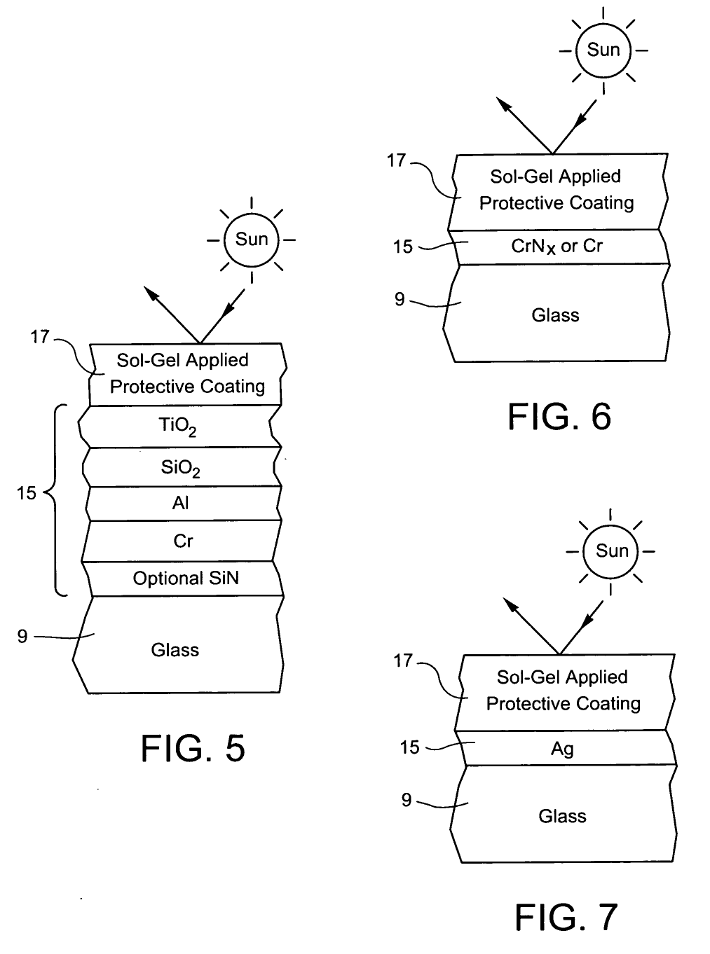

The reflective coatings 15 shown in FIG. 4 and discussed above are provided for purposes of example only, and other types of reflective coatings 15 may instead be used. FIGS. 5-7 illustrate other types of example reflective coatings 15 that may be used in FSMs according to different example embodiments of this invention. For purposes of example, the reflective coating 15 in any embodiment of this invention may be made up of any of the reflective coatings described in any of U.S. Ser. Nos. 10/945,430 or 10/959,321, the disclosures of which are hereby incorporated herein by reference. Moreover, the reflective coating 15 in any embodiment of this invention may be made up of any of the reflective coatings described in any of U.S. Pat. Nos. 6,783,253 or 6,934,085, the disclosures of which are hereby incorporated herein by reference.

FIG. 5 illustrates another example reflective coating 15 that may be used in a FSM according to an example embodiment of this invention. The protective coating 17 discussed above is provide on the glass substrate 9 over the reflective coating 15 shown in the FIG. 5 embodiment. In the FIG. 5 embodiment, both the Al and Cr layers function as reflective layers. The layers of the reflective coating 15 in the FIG. 5 embodiment are preferably deposited via sputtering, although other techniques may instead be used.

FIG. 6 illustrates another example reflective coating 15 that may be used in a FSM according to an example embodiment of this invention. The protective coating 17 discussed above is provide on the glass substrate 9 over the reflective coating 15 shown in the FIG. 6 embodiment. In the FIG. 6 embodiment, the reflective coating 15 is made up of a single reflective layer of Cr or a nitride thereof. Optional dielectric layers (not shown) need not be provided. The Cr/CrN reflective layer of the reflective coating 15 in the FIG. 6 embodiment may be deposited via sputtering.

FIG. 7 illustrates another example reflective coating 15 that may be used in a FSM according to an example embodiment of this invention. The protective coating 17 discussed above is provide on the glass substrate 9 over the reflective coating 15 shown in the FIG. 7 embodiment. In the FIG. 7 embodiment, the reflective coating 15 includes or is made up of a silver based layer that may be initially applied in wet or solid form. For instance, the reflective coating 15 may be formed by sensitizing and activating the substrate 9, and then silvering the substrate to provided a silver based layer thereon. The activating of the substrate may be performed by contacting the substrate with a solution including ion(s), and the subsequent silvering may be achieved by spraying a silvering solution onto the sensitized and activated substrate 9 to form a silver based coating 15. Copper may or may not be used. Then, after the reflective coating with the silver layer is formed, the protective coating 17 is formed as explained above.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. For example, the coatings discussed herein may in some instances be used in back surface mirror applications, different materials may be used, additional or fewer layers may be provided, and/or the like.

1. A method of making a first surface mirror, the method comprising:
forming a reflective coating on a glass substrate;
forming a sol-gel on the glass substrate over the reflective coating, the sol-gel including a Si-inclusive precursor and one or more of water, alcohol, acid, base, and/or a hydroalcoholic mixture; and
heat treating the sol-gel at from about 200 to 1,000 degrees C. for densifying and forming a glassy silica based protective coating over the reflective coating of the first surface mirror.

2. The method of claim 1, wherein the protective coating comprises at least about 75% SiO₂.

3. The method of claim 1, wherein the protective coating comprises at least about 80% SiO₂.

4. The method of claim 1, wherein the protective coating comprises at least about 85% SiO₂.

5. The method of claim 1, wherein the protective coating has an index of refraction (n) of from about 1.4 to 1.55.

6. The method of claim 1, wherein the sol-gel is formed on the substrate at approximately room temperature.

7. The method of claim 1, wherein the reflective coating comprises at least one reflective layer comprises Al or Ag.

8. The method of claim 1, wherein the reflective coating is a multi-layer coating comprising at least one reflective layer and first and second dielectric layers, wherein the reflective layer is located between the glass substrate and the first and second dielectric layers.

9. The method of claim 1, wherein the Si-inclusive precursor comprises a silane.

10. The method of claim 1, wherein the Si-inclusive precursor comprises TEOS and/or TMOS.

11. The method of claim 1, wherein the protective coating is the outermost layer of the mirror.

12. A solar collector comprising the first-surface mirror of claim 1.

13. A method of making a first surface mirror, the method comprising:
forming a reflective coating on a glass substrate;
forming a sol-gel on the glass substrate over the reflective coating, the sol-gel including a precursor and one or more of water, alcohol, acid and/or base, and/or a hydroalcoholic mixture; and
heat treating the sol-gel so as to form a solid silica based protective coating over the reflective coating of the first surface mirror.

14. The method of claim 13, wherein the protective coating comprises at least about 75% SiO₂.

15. The method of claim 13, wherein the protective coating comprises at least about 80% SiO₂.

16. A solar collector comprising the first-surface mirror of claim 13.

17. A first surface mirror, comprising:
a reflective coating supported by a glass substrate; and
a glassy silica based protective coating provided on the glass substrate over the reflective coating of the first surface mirror.

18. A solar collector comprising the first-surface mirror of claim 17.
